(19) United States
(12) Patent Application Publication
(10) Pub. No.: US 2017/0339741 A1
(43) Pub. Date: Nov. 23, 2017

(54) METHOD TO DETERMINE GAS INFORMATION AND LOCATION OF AN OPERATOR CARRYING WIRELESS GAS DETECTOR DURING GAS/MANDOWN/PANIC EVENTS ON COMMUNICATION FAILURE WITH MONITORING STATION

(71) Applicant: Honeywell International Inc., Morris Plains, NJ (US)

(72) Inventors: Irfan K, Bangalore (IN); Anand Tyagaraj, Bangalore (IN); Gowrishankar M R, Bangalore (IN)

(21) Appl. No.: 15/532,620

(22) PCT Filed: Nov. 30, 2015
(86) PCT No.: PCT/US2015/062916

§ 371 Date: Jun. 2, 2017

Related U.S. Application Data
(60) Provisional application No. 62/113,907, filed on Feb. 9, 2015.

(30) Foreign Application Priority Data
Dec. 3, 2014 (IN) 6097/CHE/2014

(51) Int. Cl. H04W 76/02; H04W 4/00; H04W 4/22; H04W 84/12

(52) U.S. Cl. CPC H04W 76/028; H04W 84/12; H04W 4/008; H04W 4/22

(57) ABSTRACT

Embodiments relate generally to systems and methods for establishing communication between an operator using a personal protection equipment (PPE) device and a central monitoring station, particularly in an emergency event. If the PPE device loses connection with a wireless network, and therefore with the central monitoring station, one or more method may be used to communicate information from the PPE device to the central monitoring station. One method may include sending a message to a predefined mobile number with location, operator, and alarm information. Another method may comprise establishing a Bluetooth connection with a secondary device, wherein the secondary device is connected to the wireless network, and sending data from the PPE device to the secondary device, wherein the secondary device forwards the data to the central monitoring station.

### CROSS-REFERENCE TO RELATED APPLICATIONS

The present application claims priority to India Provisional Patent Application No. 6097/CHE/2014 filed Dec. 3, 2014 by Irfan K et al., and entitled “Method to Determine Gas Information and Location of an Operator Carrying Wireless Gas Detector During Gas/Mandown/Panic Events on Communication Failure with Monitoring Station,” and U.S. Provisional Patent Application Ser. No. 62/113,907 filed Feb. 9, 2015 by Irfan K et al., and entitled “Method to Determine Gas Information and Location of an Operator Carrying Wireless Gas Detector During Gas/Mandown/Panic Events on Communication Failure with Monitoring Station, which are incorporated herein by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In certain work areas and facilities, workers may carry PPE devices, such as gas detectors, with them while they are working. These gas detectors may be operable to gather data on the environment and location of the worker. PPE devices may be capable of communicating with a wireless network to determine location information for the devices.

### SUMMARY

Aspects of the disclosure may include embodiments of a method of establishing communication between a personal protection equipment (PPE) device and a central monitoring station comprising: sending raw data from one or more PPE device to a central monitoring station, wherein the PPE device and the central monitoring station communicate over a Wi-Fi network; receiving and saving a current area name for the PPE device determined by the central monitoring station; determining if the PPE device is in a Panic, Gas Alarm, or Man-down state; when the device is in one of these states, determining if the device has lost connection with the Wi-Fi network; when the connection with the Wi-Fi network has been lost, activating the Bluetooth capability of the device; scanning for Bluetooth connections with nearby secondary devices, wherein the scanning may timeout after 15 seconds; when a secondary device is detected, activating the Bluetooth of the secondary device auto-pairing with the secondary device; determining if the secondary device is connected to the central monitoring station via the Wi-Fi network; when the secondary device is not connected to the central monitoring station, repeating the method from scanning for additional devices until a secondary device is found that is connected to the central station; when the secondary device is connected to the central monitoring station, forwarding alarm details from the PPE device to the secondary device, wherein the alarm details are forwarded by the secondary device to the central monitoring station, establishing communication between the PPE device and the central station.

In some embodiments, the PPE device comprises a gas detector device. In some embodiments, the method may further comprise reestablishing communication with the wireless network when the device enters the range of a wireless router. In some embodiments, the method may further comprise sending a message alert or voice alert to at least one preconfigured mobile number, wherein the alert may comprise the most recent current area name received by the PPE device from the central station, operator information, and any other detected information.

Additional aspects of the disclosure may include embodiments of a method of establishing communication between a personal protection equipment (PPE) device and a central monitoring station comprising sending data from one or more PPE device to a central monitoring station, wherein the PPE device and the central monitoring station communicate over a Wi-Fi network; receiving and saving a current area name for the PPE device determined by the central monitoring station; determining if the device has lost connection with the Wi-Fi network; when the connection with the Wi-Fi network has been lost, activating the Bluetooth capability of the device; scanning for Bluetooth connections with nearby secondary devices; when a secondary device is not detected, sending a message alert or voice alert to at least one preconfigured mobile number, wherein the alert may comprise the most recent current area name received by the PPE device from the central station, operator information, and any other detected information; when a secondary device is detected, activating the Bluetooth of the secondary device and pairing with the secondary device; determining if the secondary device is connected to the central monitoring station via the Wi-Fi network; when the secondary device is connected to the central monitoring station, forwarding data from the PPE device to the secondary device, wherein the data is forwarded by the secondary device to the central monitoring station, establishing communication between the PPE device and the central station.

In some embodiments, the method may further comprise, when the secondary device is not connected to the central monitoring station, repeating the method from scanning for additional devices until a secondary device is found that is connected to the central station. In some embodiments, the method may further comprise, when the secondary device is not connected to the central monitoring station, sending a message alert or voice alert to at least one preconfigured mobile number, wherein the alert may comprise the most recent current area name received by the PPE device from the central station, operator information, and any other detected information. In some embodiments, the method may further comprise determining that the PPE device is in an alarm status. In some embodiments, the method may further comprise including the alarm details in the message alert or voice alert sent to the preconfigured mobile number. In some embodiments, the method may further comprise forwarding the alarm details via the secondary device to the central monitoring station. In some embodiments, the PPE device comprises a gas detector device. In some embodiments, the method may further comprise reestablishing communication with the wireless network when the device enters the range of a wireless router.

Other aspects of the disclosure may include embodiments of a method of establishing communication between a personal protection equipment (PPE) device and a central monitoring station comprising sending raw data from one or more PPE device to a central monitoring station, wherein the PPE device and the central monitoring station communicate over a Wi-Fi network; receiving and saving a current area name for the PPE device determined by the central monitoring station; determining if the device has lost connection with the Wi-Fi network; when the connection with the Wi-Fi network has been lost, sending a message alert or voice alert to at least one preconfigured mobile number, wherein the alert may comprise the most recent current area name received by the PPE device from the central station, operator information, and any other detected information.

In some embodiments, the method may further comprise determining if the PPE device is in a Panic, Gas Alarm, or Man-down state. In some embodiments, the method may further comprise including the alarm details in the message alert or voice alert sent to the preconfigured mobile number. In some embodiments, the method may further comprise, when the connection with the Wi-Fi network has been lost, activating the Bluetooth capability of the device; scanning for Bluetooth connections with nearby secondary devices, wherein the scanning may timeout after 15 seconds; when a secondary device is detected, activating the Bluetooth of the secondary device auto-pairing with the secondary device; determining if the secondary device is connected to the central monitoring station via the Wi-Fi network; when the secondary device is not connected to the central monitoring station, repeating the method from scanning for additional devices until a secondary device is found that is connected to the central station; when the secondary device is connected to the central monitoring station, forwarding data from the PPE device to the secondary device, wherein the data is forwarded by the secondary device to the central monitoring station, establishing communication between the PPE device and the central station. In some embodiments, the method may further comprise determining if the PPE device is in a Panic, Gas Alarm, or Man-down state. In some embodiments, the method may further comprise forwarding the alarm details via the secondary device to the central monitoring station. In some embodiments, the PPE device comprises a gas detector device. In some embodiments, the method may further comprise reestablishing communication with the wireless network when the device enters the range of a wireless router.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a wireless communication system according to an embodiment of the disclosure; and

FIG. 2 illustrates a method for establishing communication between a PPE device and a central monitoring station according to an embodiment of the disclosure.

### DETAILED DESCRIPTION

It should be understood at the outset that although illustrative implementations of one or more embodiments are illustrated below, the disclosed devices, systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Embodiments of the disclosure relate to systems and methods for establishing communication between an operator using a personal protection equipment (PPE) device and a central monitoring station, particularly in an emergency event. Personnel working in areas where toxic gas may be in the environment may wear one or more PPE devices for detection and communication. For example, personnel may wear a portable gas detector operable identify gases in the air and determine the levels of gases in the environment. Additionally, personnel may wear portable location devices operable to send a location of the device (and therefore the location of the user) to a central monitoring station. These portable devices may communicate wirelessly, or over a wireless fidelity (Wi-Fi) network.

In some cases, the Wi-Fi connection may be lost while a user is working in an area with toxic gases present, thereby preventing communication between the portable devices worn by the user and the central monitoring station. If the connection is lost, there may be no way to know the status of the user(s) in the toxic area, including their location and the gas information of the area. Additionally, if the user falls unconscious due to inhalation of the toxic gases, it may become an emergency (such as a high gas level, man-down, or panic) event requiring urgent location and rescue of the fallen person. There is also no automated way to notify the central monitoring station, a field supervisor, and/or an emergency response team (ERT) with the details of the situation, including location and environment details.

The above mentioned issues will be addressed by implementing one or more methods of communicating the location and environment details of a device that has disconnected from Wi-Fi to the central monitoring station, field supervision and/or ERT. In other words, one or more methods are disclosed for establishing communication between a device that has disconnected from Wi-Fi and the central monitoring station (or other similar entity).

A first method comprises determining the location of the device based on the last location information communication by the central station, determining the most recent environment information obtained by the device, and, in the case of an alarm event when the Wi-Fi connection has been lost, sending out a short message service (SMS) message and/or a voice call message from the gas detector device to the central monitoring station, field supervision and/or ERT, wherein the message contains the most recent location and environment information. The device may be pre-configured with the mobile number(s) to be used when sending an SMS or voice message. The SMS or voice message may be automatically generated by the device.

A second method comprises determining the location of the device based on the last location information communication by the central station, determining the most recent environment information obtained by the device, in the case of an alarm event when the Wi-Fi connection has been lost, activating the Bluetooth function on the device, identifying (via Bluetooth) a nearby device that is enabled with Wi-Fi, connecting (via Bluetooth) with the nearby device, wherein the nearby device is operable to communicate with the central monitoring station, and sending a notification containing the most recent location and environment information to the central station via the nearby device. The nearby device may be pre-configured to forward information received from other devices to the central monitoring station.

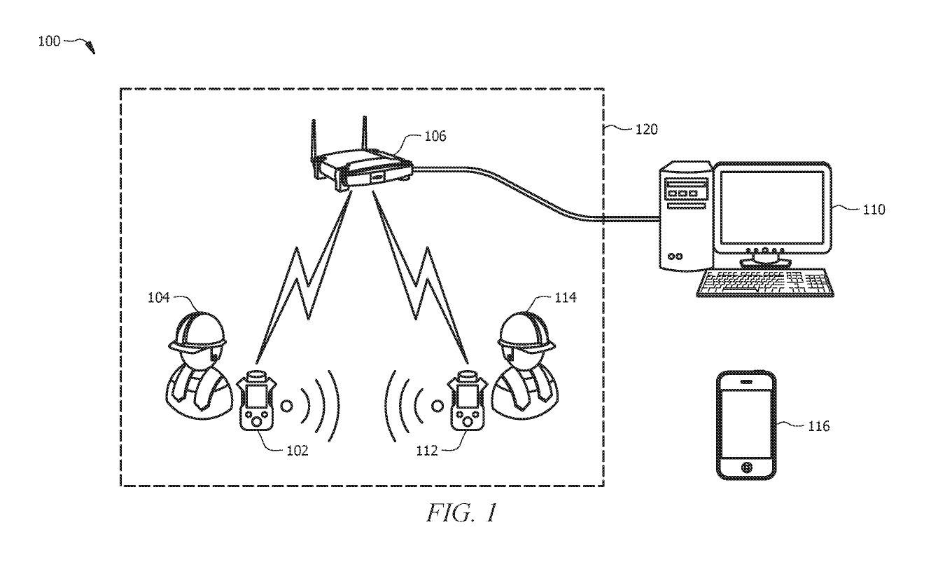

Referring to FIG. 1 a system 100 is described, wherein one or more workers 104 and 114 within a facility 120 may carry gas detector devices 102 and 112. The gas detector devices 102 and 112 may communicate via Wi-Fi with one or more router 106, wherein the router(s) 106 may direct information received from the gas detector devices 102 and 112 to the central monitoring station 110. If a first gas detector device 102 loses the Wi-Fi connection with the router(s) 106, the gas detector device 102 may be operable to activate a Bluetooth function of the device 102. The first PPE device 102 may then seek for a second Bluetooth enable device, such as a second gas detector (or PPE) device 112 carried by a second worker 114. The first device 102 may connect with the second device 112 and determine if the second device 112 is communicating with the router 106 via Wi-Fi. If the second device 112 is communicating with the router 106, the first device 102 may send information (such as gas detector information, last location information, etc.) to the second device 112, wherein the second device 112 may forward the information via the router 106 to the central monitoring station 110.

In some embodiments, the first device 102, when the Wi-Fi connection is lost, may be enabled to send an SMS message and/or voice message to a programmed mobile number, wherein the mobile number may be associated with the central monitoring station 110, and/or a supervisor mobile device 116. In some embodiments, the first device 102, when Wi-Fi connection is lost, may be enabled to send a message to more than one mobile number. In some embodiments, the SMS and/or voice message may contain the last know location information, gas readings, and alert information from the gas detector device 102.

In some embodiments, after the first device 102 has lost connection with the Wi-Fi router 106, the worker 104 and first device 102 may reenter an area where the connection with the router 106 may be reestablished. In this case, the first device 102 may cease to send information to the second device 112 via Bluetooth, and may return to the original (or default) communication with the router 106 and central monitoring station 110.

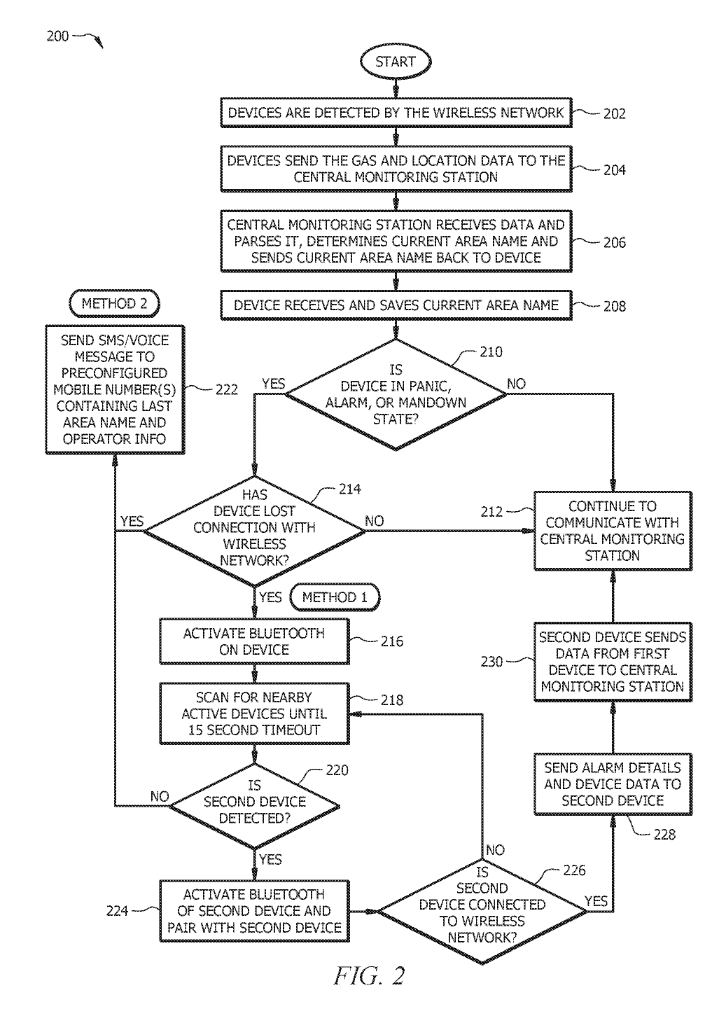

FIG. 2 illustrates a method for establishing communication between a PPE device and a central monitoring station is described. At step 202, PPE devices may be detected by the wireless access point (AP) or Wi-Fi network. At step 204, these devices may send data, such as environment (gas) and location data, to a central monitoring station (which may be called a LocaXion Manager). At step 206, the central monitoring station may receive the raw data and process (or parse) it, determining a current area name, which may be sent back to the device. At step 208, the device may receive and save the area name. Then, at step 210, it may be determined if the device is in a Panic, Gas Alarm, or Man-down state. If the device is not in one of these states, at step 212, the communication with the central monitoring station may not be interrupted, and in some embodiments, the central monitoring station may be notified of the state of the device. If the device is in one of these states, at step 214, it may then be determined if the device has lost connection with the network (i.e. the Wi-Fi connection has failed). If the connection with the network is not lost, at step 212, the communication with the central monitoring station may not be interrupted, and in some embodiments, the central monitoring station may be notified of the state of the device.

If the connection with the network has been lost, two method options are available. In a first method, at step 216, the Bluetooth capability of the device may be activated. Then, at step 218, the device may scan for Bluetooth connections with nearby secondary devices, wherein the scanning may timeout after 15 seconds. If a secondary device is detected, at step 220, the Bluetooth of the secondary device may be activated, at step 224, and the device may auto-pair with the secondary device. Then, at step 226, it may be determined if the secondary device is connected to the wireless network, and therefore the central monitoring station. If the secondary device is not connected to the central station, the method may repeat from step 218, scanning for additional devices until a secondary device is found that is connected to the central station. When the secondary device is connected to the central station, at step 228, alarm details may be forwarded from the PPE device to the secondary device. Then, at step 230, the alarm details may be forwarded by the secondary device to the central monitoring station, establishing communication between the PPE device and the central station. The first and second devices may continue to communicate with the central monitoring station, step 212, in this way until something changes, such as the first device reconnects to the wireless network and/or the second device loses connection with the wireless network.

If a secondary device is not detected during the Bluetooth scan (at step 220), the method may proceed to a second method option. The second method, step 222, may comprise sending an SMS alert and/or voice alert to a preconfigured mobile number (or numbers), wherein the alert may comprise the most recent current area name received by the PPE device from the central station, operator information, and any other detected information. This may establish communication between the PPE device and personnel at the central monitoring station.

In an alternative embodiment, the first and second methods could happen simultaneously when it is determined, at step 214, that the connection with the wireless network has been lost.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1-15. (canceled)

16. A method of establishing communication between a personal protection equipment (PPE) device and a central monitoring station comprising:
sending, by the PPE device, raw data to a central monitoring station, wherein the PPE device and the central monitoring station communicate over a Wi-Fi network;
receiving and saving, by the PPE device, a current area name for the PPE device determined by the central monitoring station;
determining, by the PPE device, if the PPE device is in a Panic, Gas Alarms,or Man-down state;
when the PPE device is in one of these states, determining, by the PPE device, if the PPE device has lost connection with the Wi-Fi network;
when the connection with the Wi-Fi network has been lost, transmitting, by one of the PPE device and a secondary device, a Bluetooth beacon;
receiving the Bluetooth beacon by the device not transmitting the Bluetooth beacon;
establishing additional Bluetooth communication between the secondary device and the PPE device;
determining, by the PPE device, if the secondary device is connected to the central monitoring station via the Wi-Fi network;
when the secondary device is not connected to the central monitoring station, repeating the method from receiving the Bluetooth beacon by the device not transmitting the Bluetooth beacon until a secondary device is found that is connected to the central monitoring station;
when the secondary device is connected to the central monitoring station, forwarding alarm details by the PPE device to the secondary device, wherein the alarm details are forwarded by the secondary device to the central monitoring station, thereby establishing communication between the PPE device and the central monitoring station.

17. The method of claim 16, wherein the PPE device comprises a gas detector device.

18. The method of claim 16, further comprising reestablishing communication between the PPE device and the Wi-Fi network when the PPE device enters the range of a wireless router of the Wi-Fi network.

19. The method of claim 16, further comprising sending, by the PPE device, a message alert or voice alert to at least one preconfigured mobile number, wherein the alert comprises one or more of the most recent current area name received by the PPE device from the central monitoring station, operator information, and any other detected information.

20. A method of establishing communication between a personal protection equipment (PPE) device and a central monitoring station comprising:
sending data from one or more PPE device to a central monitoring station, wherein the PPE device and the central monitoring station communicate over a Wi-Fi network;
determining if the PPE device has lost connection with the Wi-Fi network;
when the connection with the Wi-Fi network has been lost, transmitting, by the PPE device, a Bluetooth beacon
receiving, by a secondary device, the Bluetooth beacon from the PPE device;
activating, by the secondary device, additional Bluetooth communication between the secondary device and the PPE device;
determining, by the PPE device, if the secondary device is connected to the central monitoring station via the Wi-Fi network;
when the secondary device is connected to the central monitoring station, forwarding data by the PPE device to the secondary device, wherein the data is forwarded by the secondary device to the central monitoring station, thereby establishing communication between the PPE device and the central monitoring station.

21. The method of claim 20, further comprising, when the secondary device is not connected to the central monitoring station, continuing to transmit the Bluetooth beacon by the PPE device until a secondary device is found that is connected to the central monitoring station.

22. The method of claim 20, further comprising, when the secondary device is not connected to the central monitoring station or when the Bluetooth beacon is not received by a secondary device, sending, by the PPE device, a message alert or voice alert to at least one preconfigured mobile number.

23. The method of claim 22, further comprising determining that the PPE device is in an a state.

24. The method of claim 23, further comprising including the alarm details in the message alert or voice alert sent to the preconfigured mobile number.

25. The method of claim 20, further comprising determining that the PPE device is in an alarm state, and forwarding the alarm details via the secondary device to the central monitoring station.

26. The method of claim 20, wherein the PPE device comprises a gas detector device.

27. The method of claim 20, further comprising reestablishing communication by the PPE device with the Wi-Fi network when the PPE device enters the range of a wireless router of the Wi-Fi network.

28. A communication system comprising:
at least one personal protection equipment (PPE) device configured to:
send data from the at least one PPE device to a central monitoring station, wherein the PPE device and the central monitoring station communicate over a Wi-Fi network;
determine if the PPE device has lost connection with the Wi-Fi network; and
when the connection with the Wi-Fi network has been lost, transmit a Bluetooth beacon; and
at least one secondary device configured to:
send data from the at least one secondary device to the central monitoring station, wherein the secondary device and the central monitoring station communicate over the Wi-Fi network;
receive the Bluetooth beacon transmitted y the PPE device;
establish Bluetooth communication between the secondary device and the PPE device;
receive data from the PPE device; and
forward the received data from the PPE device to the central monitoring station.

29. The communication system of claim 28, wherein the PPE device is further configured to determine that the PPE device in a Panic, Gas Alarm, or Man-down state.

30. The communication system of claim 28, wherein the PPE device is further configured to receive a current area name for the PPE device determined by the central monitoring station.

31. The communication system of claim 30, wherein the data forwarded by the secondary device from the PPE device to the central monitoring station comprises one or more of the most recent current area name received by the PPE device from the central monitoring station, operator information, and any other detected information.

32. The communication system of claim 30, wherein the PPE device is further configured to send a message alert or voice alert to at least one preconfigured mobile number, wherein the alert comprises one or more of the most recent current area name received by the PPE device from the central monitoring station, operator information, and any other detected information.

33. The communication system of claim 28, further comprising the central monitoring station configured to:
receive data from at least one PPE device over the Wi-Fi network;
determine the current area name for the PPE device based on the received data;
send the current area name to the PPE device.

34. The communication system of claim 33, wherein the central monitoring station is further configured to: receive data from the secondary device over the Wi-Fi network; and receive data from the PPE device forwarded by the secondary device over the Wi-Fi network.

35. The communication system of claim 28, wherein the PPE device comprises a gas detector.
